(19) United States
(12) Patent Application Publication
(10) Pub. No.: US 2026/0065543 A1
(43) Pub. Date: Mar. 5, 2026

(54) MODULATING FIDELITY AND DETAIL IN IMAGE VECTORIZATION

(71) Applicant: ADOBE INC., SAN JOSE, CA (US)

(72) Inventors: Keerti Harpavat, Rajasthan (IN); Arshdeep Singh Chugh, New Delhi (IN); Ashwani Chandil, Noida (IN); Vishwas Jain, Bangalore (IN); Vineet Batra, Delhi (IN)

(21) Appl. No.: 18/816,366

(22) Filed: Aug. 27, 2024

(51) Int. Cl. G06T 11/60; G06F 40/40

(52) U.S. Cl. CPC G06T 11/60; G06F 40/40; G06T 2210/36

(57) ABSTRACT

A method, apparatus, non-transitory computer readable medium, and system for modulating the level of fidelity to an input image include obtaining an input image and a fidelity parameter. The input image depicts an entity, and the fidelity parameter indicates a level of fidelity, i.e., faithfulness, to the input image. Embodiments then add noise to the input image based on the fidelity parameter to obtain an intermediate noise image. Subsequently, embodiments generate a synthetic image based on the intermediate noise image using an image generation model. The synthetic image includes a vectorizable depiction of the entity and has the level of fidelity to the input image indicated by the fidelity parameter. The vectorizable depiction is more suitable for conversion to vector format, as the resulting vector image will have a reduced number of paths and shapes.

### BACKGROUND

The following relates generally to image processing, and more specifically to image vectorization. Image processing is a type of data processing that involves the manipulation of an image to get the desired output, typically utilizing specialized algorithms and techniques. It is a method used to perform operations on an image to enhance its quality or to extract useful information from it. This process usually comprises a series of steps that includes the importation of the image, its analysis, manipulation to enhance features or remove noise, and the eventual output of the enhanced image or salient information it contains.

Image processing techniques are also used for image generation. For example, machine learning (ML) techniques have been applied to create generative models that can produce new image content. One use for generative AI is to create images based on an input prompt. This task is often referred to as a “text to image” task or simply “text2img”. Some models such as GANs and Variational Autoencoders (VAEs) employ an encoder-decoder architecture with attention mechanisms to align various parts of text with image features. Newer approaches such as denoising diffusion probabilistic models (DDPMs) iteratively refine generated images in response to textual prompts. These models are typically used to produce images in the form of pixel data, which represents images as a matrix of pixels, where each pixel includes color information.

### SUMMARY

Embodiments of the inventive concepts described herein include systems and methods for transforming photo-realistic images to vectorizable images. This type of transformation is referred to as “semantic translation,” as the process preserves the semantic integrity of the original image while adding vectorizable characteristics to the generated image. The term “vectorizable,” as used herein, describes attributes of an image that enables it to be efficiently and accurately translated from pixel data to vector image format. Characteristics of vectorizable images may include, but are not limited to, flat or solid color regions, clearly defined shapes or boundaries, and the absence of gradient transitions or fuzzy edges. Embodiments are configured to synthesize a vectorizable image from a photo-realistic input image based on an input “fidelity parameter,” which indicates a desired level of fidelity of the synthesized image to the input image. To adjust the level of fidelity to an input image, embodiments modulate an amount of noise added to the input image to form an intermediate image, which is then input to a generative diffusion model. Embodiments control the level of detail in the final vector image through modulation of a style embedding. In some embodiments, a style embedding is generated from a style prompt, and the style embedding is selectively applied at one or more diffusion steps of an image generation model, where the selected diffusion steps are based on an input detail parameter. In some embodiments, the style prompt is adjusted through prompt engineering before being transformed into the style embedding, where the prompt engineering is based on the detail parameter. Further still, in some embodiments the style embedding is weighted before being applied via e.g., cross-attention, to the image generation model.

A method, apparatus, non-transitory computer readable medium, and system for image vectorization are described. One or more aspects of the method, apparatus, non-transitory computer readable medium, and system include obtaining an input image and a fidelity parameter, wherein the input image depicts an entity and the fidelity parameter indicates a level of fidelity to the input image; adding noise to the input image based on the fidelity parameter to obtain an intermediate noise image; and generating, using an image generation model, a synthetic image based on the intermediate noise image, wherein the synthetic image includes a vectorizable depiction of the entity and has the level of fidelity to the input image indicated by the fidelity parameter.

A method, apparatus, non-transitory computer readable medium, and system for image vectorization are described. One or more aspects of the method, apparatus, non-transitory computer readable medium, and system include obtaining an input image, a fidelity parameter, and a detail parameter; adding noise to the input image based on the fidelity parameter to obtain an intermediate noise image; generating a style guidance based on the detail parameter; and generating a synthetic image based on the intermediate noise image and the style guidance, wherein the synthetic image has a level of fidelity to the input image indicated by the fidelity parameter and has a level of detail indicated by the detail parameter.

An apparatus, system, and method for image vectorization are described. One or more aspects of the apparatus, system, and method include at least one processor; at least one memory storing instructions executable by the at least one processor; and an image generation model comprising parameters stored in the at least one memory and configured to add noise to an input image based on a fidelity parameter to obtain an intermediate noise image and to generate a synthetic image based on the intermediate noise image, wherein the synthetic image has a level of fidelity to the input image as indicated by a fidelity parameter and has a level of detail as indicated by a detail parameter.

### BRIEF DESCRIPTION OF THE DRAWINGS

FIG. 1 shows an example of an image processing system according to aspects of the present disclosure.

FIG. 2 shows an example of an image processing apparatus according to aspects of the present disclosure.

FIG. 3 shows an example of a latent diffusion model according to aspects of the present disclosure.

FIG. 4 shows an example of a prompt augmentation component according to aspects of the present disclosure.

FIG. 5 shows an example of a pipeline for vectorizing images according to aspects of the present disclosure.

FIG. 6 shows an example of a method for generating a synthetic image with controllable fidelity according to aspects of the present disclosure.

FIG. 7 shows an example of a method for providing a user with a vector image according to aspects of the present disclosure.

FIG. 8 shows an example of a graphical user interface according to aspects of the present disclosure.

FIG. 9 shows an example of a computing device according to aspects of the present disclosure.

### DETAILED DESCRIPTION

Image generation is frequently used in creative workflows. Historically, users would rely on manual techniques and drawing software to create visual content. The advent of machine learning (ML) has enabled new workflows that automate the image creation process.

ML is a field of data processing that focuses on building algorithms capable of learning from and making predictions or decisions based on data. It includes a variety of techniques, ranging from simple linear regression to complex neural networks, and plays a significant role in automating and optimizing tasks that would otherwise require extensive human intervention.

Generative models in ML are algorithms designed to generate new data samples that resemble a given dataset. Generative models are used in various fields, including image generation. They work by learning patterns, features, and distributions from a dataset and then using this understanding to produce new, original outputs.

In the image generation domain, generative models typically produce outputs that are in a rasterized, pixel data format. In some cases, users wish to work with vector format images instead. A vector image format refers to a type of digital graphic representation that utilizes mathematical equations to define paths and shapes, rather than mapping individual pixels, facilitating scalable and resolution-independent rendering of the image elements. This format allows for precise manipulation of image attributes such as colors, shapes, and outlines without degradation in quality, making it a preferred format for logos and illustrations. There are a plethora of available software tools for vector image editing.

Further, there are systems and methods for converting pixel-based images into vector images. For example, certain heuristic-based and rule-based algorithms can generate path and shape data from pixels based on local contrasts and segmentation operations. However, when operating on detailed and photo-realistic images, the resultant vector format image will include an excessive number of paths and anchor points, reducing the editability of the image. This can further result in increased computational and storage demands.

Accordingly, the vectorization tools work best on images with lower high frequency detail. Such images are termed “vectorizable.” “Vectorizable,” as used herein, describes attributes of an image that enables it to be efficiently and accurately translated from pixel data to vector image format. Characteristics of vectorizable images may include, but are not limited to, flat or solid color regions, clearly defined shapes or boundaries, and the absence of gradient transitions or fuzzy edges. These attributes facilitate a seamless conversion process, minimizing data loss and retaining the fidelity of the original image attributes during the transformation from a rasterized format to a vectorized representation. Conversely, non-vectorizable images, characterized by complex textures, gradients, or undefined boundaries, are prone to generating excessive paths during the vectorization process.

Generative ML models such as diffusion models will typically produce non-vectorizable images, due to their large pre-training process that involves highly detailed and photo-realistic images. In some cases, these models can be conditioned on a text prompt that includes style elements such as “vector style,” “vector aesthetic,” and the like. However, though they may be vectorizable, the resulting images can be overly cartoonish or compromise on semantic details. Further, some users may wish to use their own images as a starting point in the vectorization process, rather than a synthetic image. There is accordingly a need for techniques to generate vectorizable images with precisely controllable detail, as well as fidelity to an input image.

Embodiments of the present disclosure provide increased control in vector image generation. Specifically, embodiments enable precise control over the level of fidelity—that is, faithfulness to an input image—and the level of detail in the final vector image. Embodiments are configured to adjust an amount of noise that is added to an input image based on an input fidelity parameter. In some cases, the amount of noise added increases with a decrease in the fidelity parameter. Embodiments control the level of detail in the final vector image through modulation of a style embedding. In some embodiments, a style embedding is generated from a style prompt, and the style embedding is selectively applied at one or more diffusion steps of an image generation model, where the selected diffusion steps are based on an input detail parameter. In some embodiments, the style prompt is adjusted before being transformed into the style embedding according to the detail parameter. Once generated, the vectorizable image is input to a vectorization component to produce a vector format image. Accordingly, embodiments enable precise user control of fidelity and detail in the final vector image.

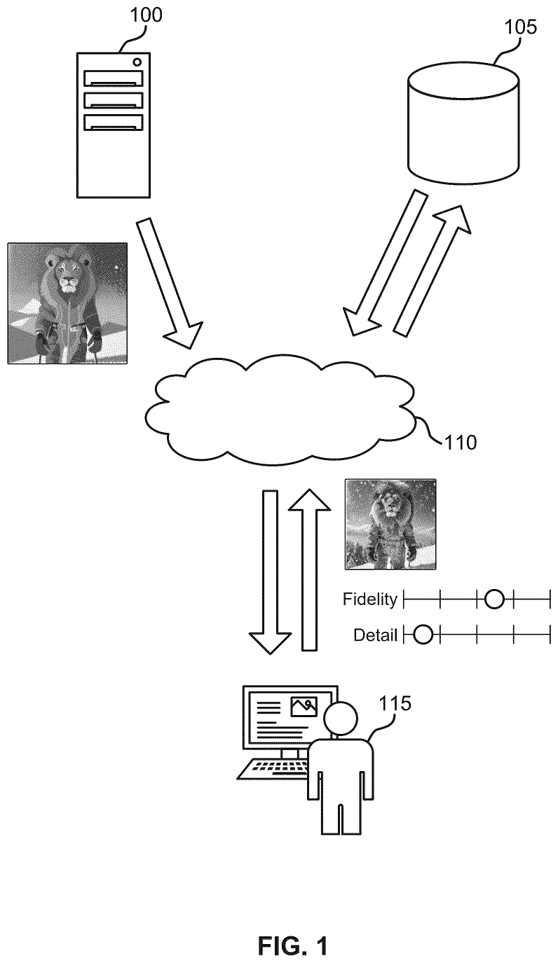

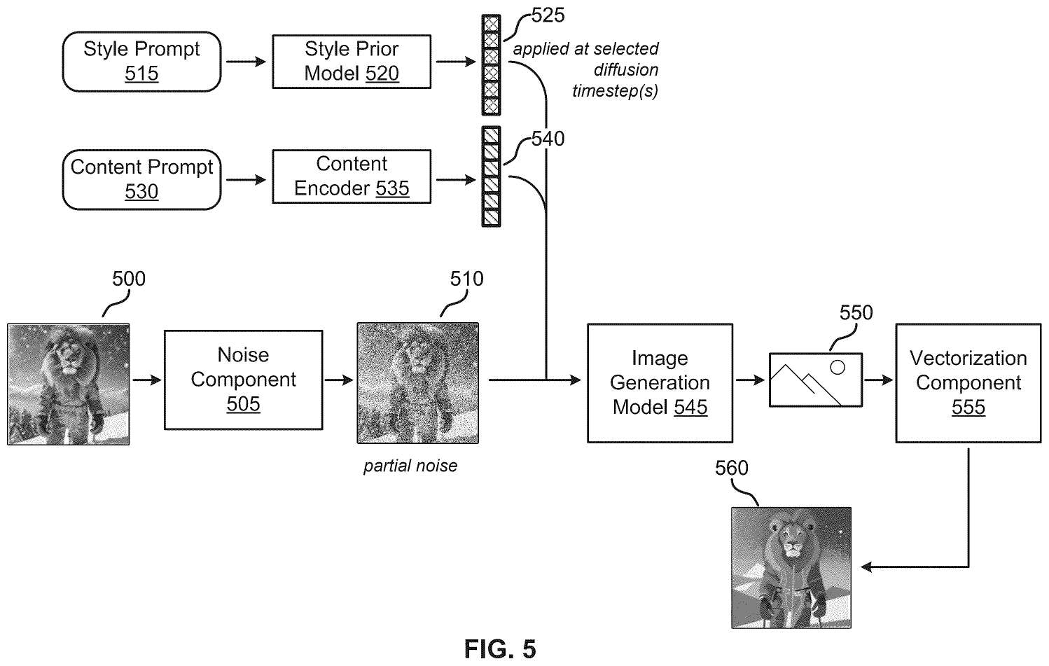

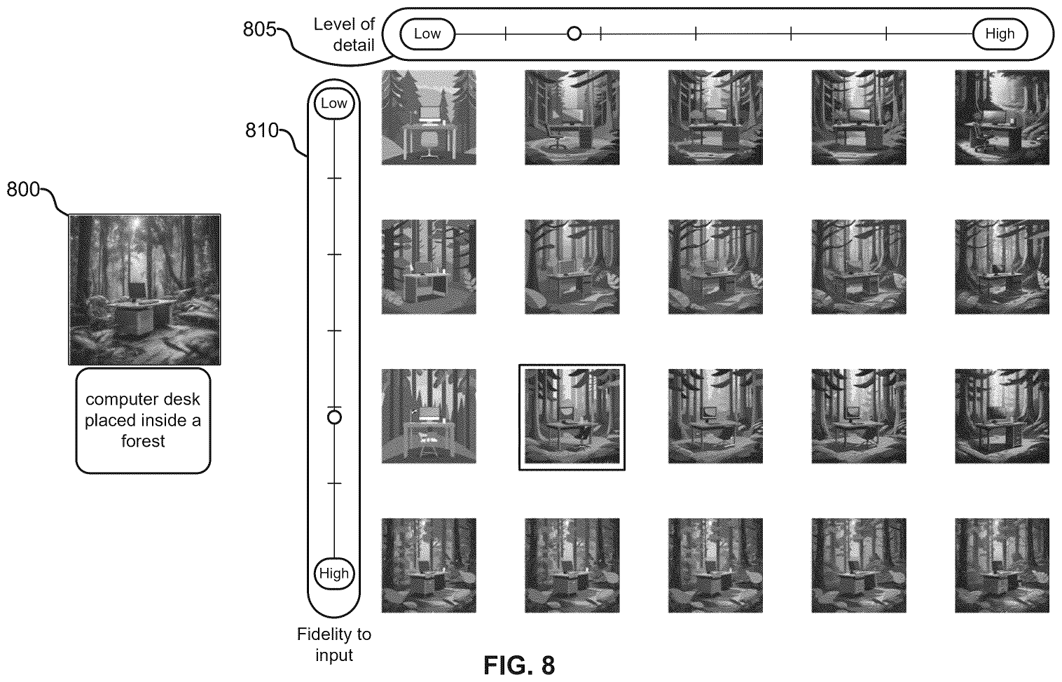

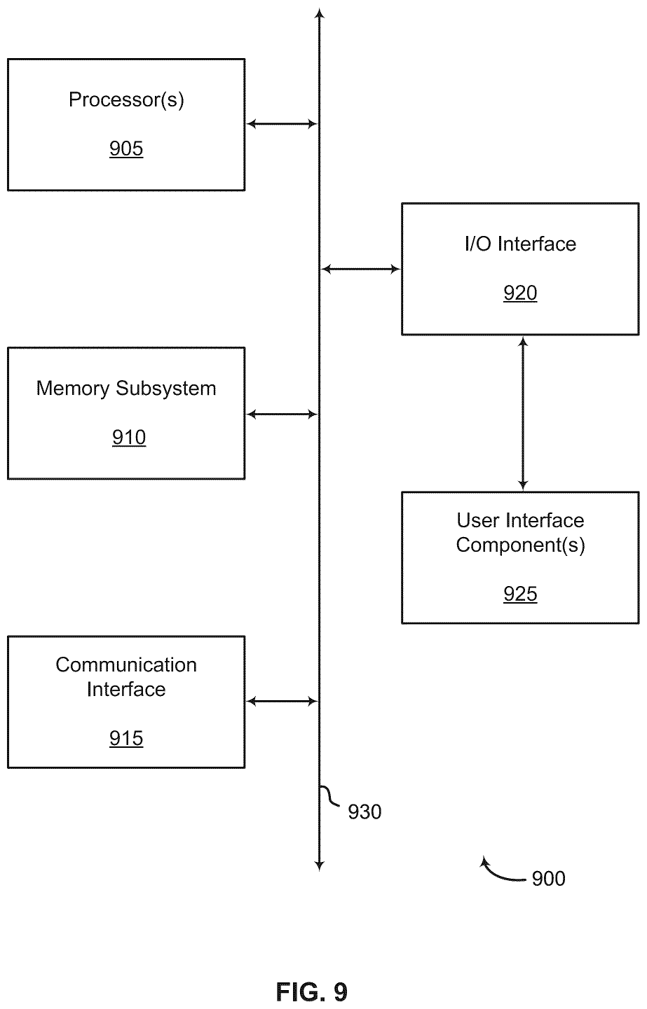

An image processing system is described with reference to FIGS. 1-4. Systems and methods for generating vectorizable images with precise fidelity and detail are described with reference to FIGS. 5-7. User interface elements for controlling a fidelity parameter and a detail parameter, as well as example results for different values of those parameters, are described with reference to FIG. 8. A computing device configured to implement an image processing apparatus is described with reference to FIG. 9.

### Image Processing System

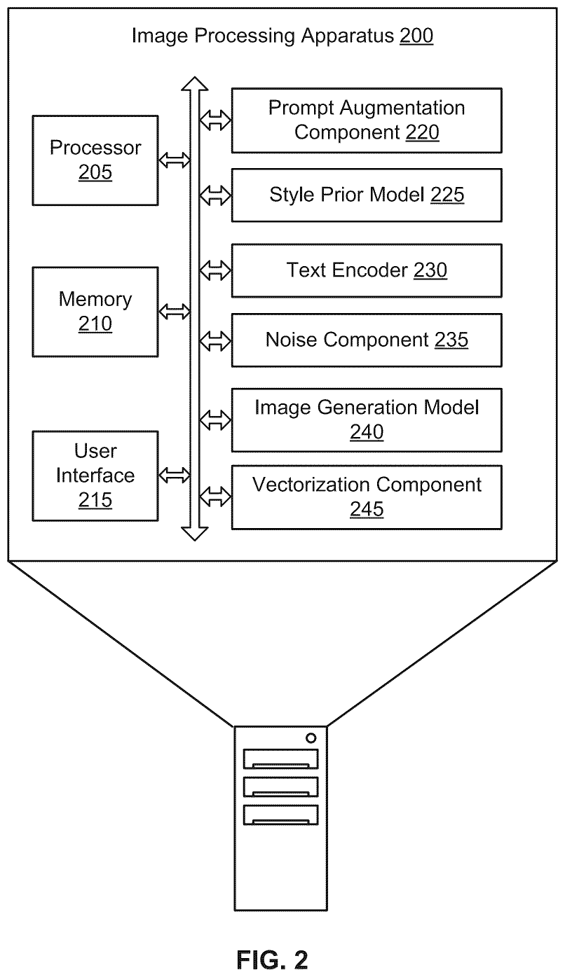

FIG. 1 shows an example of an image processing system according to aspects of the present disclosure. The example shown includes image processing apparatus 100, database 105, network 110, and user 115. Image processing apparatus 100 is an example of, or includes aspects of, the corresponding element described with reference to FIG. 2.

In this example, a user 115 provides an input image for vectorization. The user 115 further provides a fidelity parameter and a detail parameter. The fidelity parameter indicates a desired level of semantic adherence of the vectorized image to the input image. Semantic adherence, sometimes referred to herein as “faithfulness,” refers to an amount of semantic similarity that is transferred to the output. For example, a high fidelity parameter may ensure that the lion in the Figure wears the same color and style of jacket, gloves, has similar facial features, and similar background elements. The detail parameter indicates a desired level of detail in the final vector format image. A high level of detail may result in a vector image with increased file size due to a large number of paths and shapes, and may be appropriate in some contexts and not appropriate in others. For example, a lower level of detail may be more appropriate when a simpler design is desired, or if the vector image will be used for a small icon. After supplying the inputs, image processing apparatus 100 generates a vector format version of the input image with a level of fidelity indicated by the fidelity parameter and a level of detail indicated by the detail parameter.

In some embodiments, all or part of image processing apparatus 100 is implemented on a server. A server provides one or more functions to a user 115 linked by way of one or more of various networks, such as network 110. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

Database 105 stores information used by the image processing system, such as machine learning model parameters, code, stock images, training data, user profile data, and the like. A database is an organized collection of data. For example, database 105 stores data in a specified format known as a schema. A database may be structured as a single database, a distributed database, multiple distributed databases, or an emergency backup database. In some cases, a database controller may manage data storage and processing in database 105. In some cases, user 115 interacts with the database controller. In other cases, the database controller may operate automatically without user interaction.

Network 110 facilitates the transfer of information between user 115, image processing apparatus 100, and database 105. In some cases, network 110 is referred to as a “cloud.” A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user, such as user 115. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

FIG. 2 shows an example of an image processing apparatus 200 according to aspects of the present disclosure. The example shown includes image processing apparatus 200, processor 205, memory 210, user interface 215, prompt augmentation component 220, style prior model 225, text encoder 230, noise component 235, image generation model 240, and vectorization component 245. Image processing apparatus 200 is an example of, or includes aspects of, the corresponding element described with reference to FIG. 1.

A processor 205is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor 210 is configured to operate a memory array using a memory controller. In other cases, a memory controller is integrated into the processor 205. In some cases, processor 205is configured to execute computer-readable instructions stored in memory 210 to perform various functions. In some embodiments, processor 205includes special purpose components for modem processing, baseband processing, digital signal processing, or transmission processing.

Memory 210stores data used during operation of image processing apparatus 200. Memory 210may, for example, pull data from a database as described in FIG. 1. Examples of a memory device include random access memory (RAM), read-only memory (ROM), or a hard disk. Examples of memory devices include solid state memory and a hard disk drive. In some examples, memory 210is used to store computer-readable, computer-executable software including instructions that, when executed, cause processor 205 to perform various functions described herein. In some cases, memory 210contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 210store information in the form of a logical state.

User interface 215 allows a user to input or specify an input image for processing. A user interface may enable a user to interact with a device. In some embodiments, the user interface may include an audio device, such as an external speaker system, an external display device such as a display screen, or an input device (e.g., remote control device interfaced with user interface 215 directly or through an IO controller module). In some cases, a user interface may be a graphical user interface (GUI).

Prompt augmentation component 220 is configured to augment an input text prompt. This process is sometimes referred to as “prompt engineering,” and influences the behavior of downstream models such as the style prior model 225, text encoder 230, and the image generation model 240. Embodiments of prompt augmentation component 220 add elements to an input content prompt and an input style prompt to produce an augmented content prompt and an augmented style prompt, respectively.

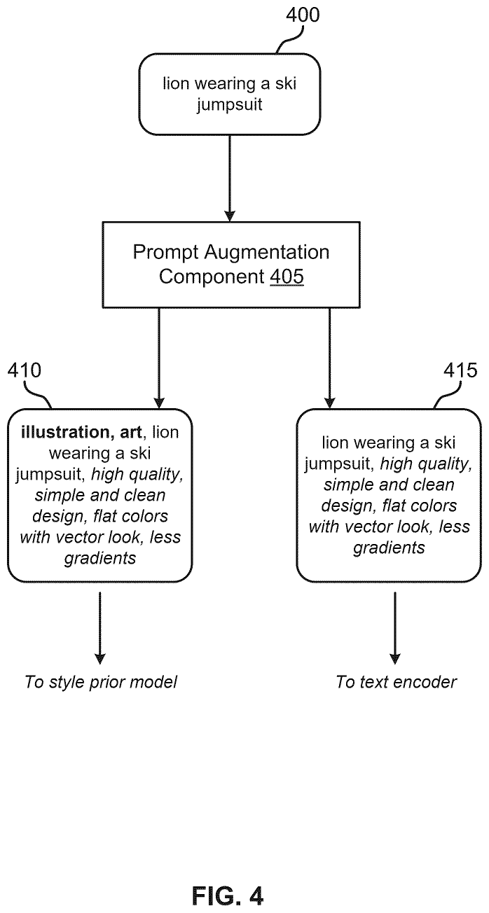

According to some aspects, prompt augmentation component 220 augments the text prompt based on the detail parameter, where the style guidance is generated based on the augmented text prompt. Prompt augmentation component 220 is an example of, or includes aspects of, the corresponding element described with reference to FIG. 4.

Components of image processing apparatus 200 such as style prior model 225, text encoder 230, and image generation model 240 may be implemented using an artificial neural network architecture). An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

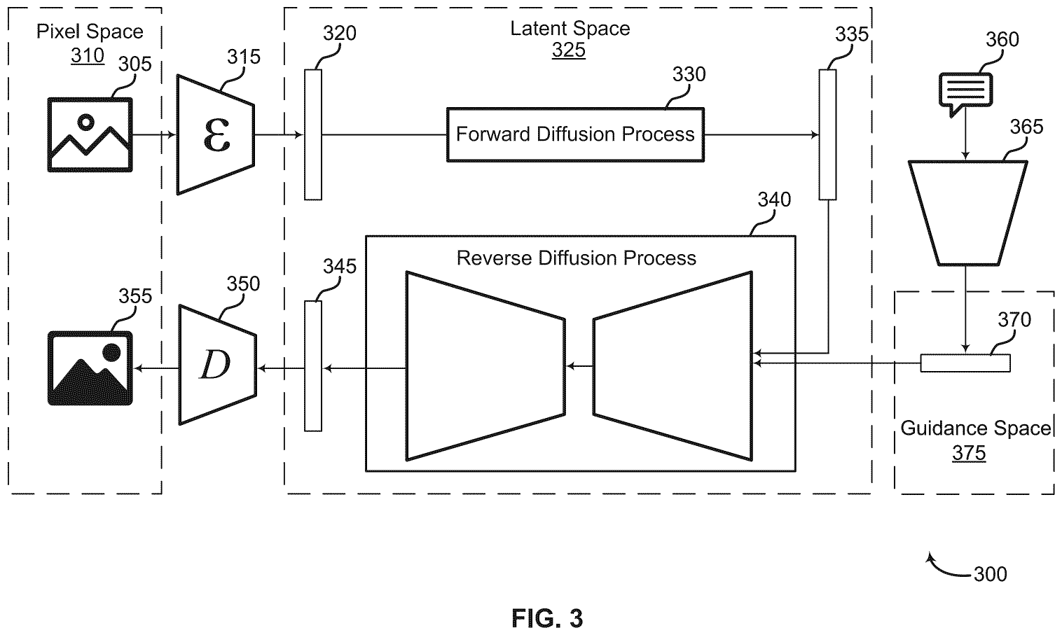

Style prior model 225 is configured to translate an input text, such as a style prompt, into an image embedding. For example, embodiments of style prior model 225 encode an input text into a vector within a multimodal embedding space. The multimodal embedding space may be, for example, a CLIP (Contrastive Language-Image Pre-training) embedding space, though embodiments are not necessarily limited thereto. In the CLIP embedding space, both text and images are encoded into a shared latent space, allowing for the comparison and alignment of concepts across modalities. This enables the style prior model to understand and interpret the stylistic nuances conveyed by the text as if they were visual features. Embodiments of style prior model 225 include a diffusion model, and perform the translation from the input text to an image embedding (a style embedding) via a reverse diffusion process, which will be described in detail with reference to FIG. 3.

According to some aspects, style prior model 225 generates style guidance based on the detail parameter, where the synthetic image is generated based on the style guidance and includes the level of detail indicated by the detail parameter. In some examples, style prior model 225 weights the style guidance based on the detail parameter. In some examples, style prior model 225 provides the style guidance to the image generation model 240 at a diffusion step selected based on the detail parameter. Style prior model 225 is an example of, or includes aspects of, the corresponding element described with reference to FIG. 5.

Text encoder 230 is configured to generate a text embedding from an input text. An embedding is a numerical vector representation of the input text. This embedding is generated by text encoder 230 and captures the semantic meaning of the text. The process involves transforming the words and phrases of the input text into a high-dimensional space where similar meanings are represented by vectors that are close to each other in the space. Embodiments of text encoder 230 include a transformer-based encoder, such as Flan-T5 or the text encoder of the CLIP network.

A transformer or transformer network is a type of neural network models used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a. Text encoder 230 is an example of, or includes aspects of, the corresponding element described with reference to FIG. 3.

Noise component 235 is configured to add noise to an input image to generate an intermediate image with partial noise. In some examples, noise component 235 selects a noise level based on the fidelity parameter, where the noise level decreases as the fidelity parameter increases. Noise component 235 is an example of, or includes aspects of, the corresponding element described with reference to FIG. 5.

Image generation model 240 is configured to generate image content. Embodiments of image generation model 240 generate content through a diffusion process, which will be described in detail with reference to FIG. 3. In some cases, image generation model 240 is used to generate an initial input image according to a text prompt, which is then partially noised according to an input fidelity parameter, and this noised image is then re-input to image generation model 240.

According to some aspects, image generation model 240 generates a synthetic image based on the intermediate noise image, where the synthetic image includes a vectorizable depiction of the entity and has the level of fidelity to the input image indicated by the fidelity parameter. In some examples, image generation model 240 selects a diffusion sampling schedule based on the fidelity parameter. In some aspects, an initial diffusion step of the diffusion sampling schedule increases as the fidelity parameter increases. For example, an increase in the initial diffusion step may refer to beginning the denoising diffusion process at a later point in the denoising schedule, and may correspond to an increased amount of added noise to the input image. In some aspects, the image generation model 240 includes a latent diffusion model, which will be described with reference to FIG. 3. Image generation model 240 is an example of, or includes aspects of, the corresponding element described with reference to FIG. 5.

Vectorization component 245 is configured to perform a vectorization process to translate an input pixel-based image into a vector image. This process involves identifying distinct color regions and their boundaries within the image, and then converting these areas into a vector format, such as a scalable vector graphics (SVG) format. Vectorization component 245 may use computer vision techniques and other heuristics to analyze the image to simplify gradients and textures into flat color areas. According to some aspects, vectorization component 245 is configured to generate a vector image based on the synthetic image. Vectorization component 245 is an example of, or includes aspects of, the corresponding element described with reference to FIG. 5.

FIG. 3 shows an example of a latent diffusion model according to aspects of the present disclosure. The example shown includes guided latent diffusion model 300, original image 305, pixel space 310, image encoder 315, original image features 320, latent space 325, forward diffusion process 330, noisy features 335, reverse diffusion process 340, denoised image features 345, image decoder 350, output image 355, text prompt 360, text encoder 365, and guidance features 370. Text encoder 365 is an example of, or includes aspects of, the corresponding element described with reference to FIG. 2.

In some examples, diffusion models are based on a neural network architecture known as a U-Net. The U-Net takes input features having an initial resolution and an initial number of channels, and processes the input features using an initial neural network layer (e.g., a convolutional network layer) to produce intermediate features. The intermediate features are then down-sampled using a down-sampling layer such that down-sampled features have a resolution less than the initial resolution and a number of channels greater than the initial number of channels.

This process is repeated multiple times, and then the process is reversed. That is, the down-sampled features are up-sampled using up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features could include a vector representation of an input prompt. The additional input features can be combined with the intermediate features within the neural network at one or more layers. For example, a cross-attention module can be used to combine the additional input features and the intermediate features.

A diffusion process may also be modified based on conditional guidance. In some cases, a user provides a text prompt describing content to be included in a generated image. For example, a user may provide the prompt “a person playing with a cat”. In some examples, guidance can be provided in a form other than text, such as via an image, a sketch, or a layout. The system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the system generates an image based on the noise map and the conditional guidance vector.

A diffusion process can include both a forward diffusion process for adding noise to an image (or features in a latent space) and a reverse diffusion process for denoising the images (or features) to obtain a denoised image. The forward diffusion process can be represented as q(xₜ|xₜ₋₁), and the reverse diffusion process can be represented as p(xₜ₋₁|xₜ). In some cases, the forward diffusion process is used during training to generate images with successively greater noise, and a neural network is trained to perform the reverse diffusion process (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process, the model begins with noisy data x_{T}, such as a noisy image and denoises the data to obtain the p(xₜ₋₁|xₜ). At each step t−1, the reverse diffusion process takes xₜ, such as first intermediate image, and t as input. Here, t represents a step in the sequence of transitions associated with different noise levels, The reverse diffusion process outputs xₜ₋₁, such as second intermediate image iteratively until x_{T} is reverted back to x₀, the original image. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) .$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) ,$$

where p(x_{T})=N(x_{T}; 0,I) is the pure noise distribution as the reverse process takes the outcome of the forward process, a sample of pure noise, as input and Πₜ₌₁^{T}p_{θ}(xₜ₋₁|xₜ) represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

A diffusion model may be trained using both a forward and a reverse diffusion process. In one example, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

The system then adds noise to a training image using a forward diffusion process in N stages. In some cases, the forward diffusion process is a fixed process where Gaussian noise is successively added to an image. In latent diffusion models, the Gaussian noise may be successively added to features in a latent space.

At each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

The training system compares predicted image (or image features) at stage n−1 to an actual image (or image features), such as the image at stage n−1 or the original input image. For example, given observed data x, the diffusion model may be trained to minimize the variational upper bound of the negative log-likelihood-log pe (x) of the training data. The training system then updates parameters of the model based on the comparison. For example, parameters of a U-Net may be updated using gradient descent. Time-dependent parameters of the Gaussian transitions can also be learned.

FIG. 4 shows an example of a prompt augmentation component 405 according to aspects of the present disclosure. The example shown includes base prompt 400, prompt augmentation component 405, style prompt 410, and content prompt 415. Prompt augmentation component 405 is an example of, or includes aspects of, the corresponding element described with reference to FIG. 2. Style prompt 410 is an example of, or includes aspects of, the corresponding element described with reference to FIG. 5. Content prompt 415 is an example of, or includes aspects of, the corresponding element described with reference to FIG. 5.

In this example, prompt segmentation component 405 receives base prompt 400. Then, prompt segmentation component 405 prepends stylistic elements “illustration” and “art” to the base prompt 400, as well as appends vectorizable terms such as “simple and clean design,” “flat colors with vector look,” etc. to generate style prompt 410. Prompt generation component 405 further appends the vectorizable terms to the base prompt 400 to generate content prompt 415. The style prompt 410 is then input to style prior model to be processed into a style embedding, which may be an image embedding in a multimodal space. Content prompt 415. The content prompt 415 is input to the text encoder to be processed into a content embedding, which may be a text embedding in a multimodal space. Additional detail regarding the multimodal space is described with reference to FIG. 2.

Accordingly, an apparatus for image vectorization is described. One or more aspects of the apparatus include at least one processor; at least one memory storing instructions executable by the at least one processor; and an image generation model comprising parameters stored in the at least one memory and configured to add noise to an input image based on a fidelity parameter to obtain an intermediate noise image and to generate a synthetic image based on the intermediate noise image, wherein the synthetic image has a level of fidelity to the input image as indicated by a fidelity parameter and has a level of detail as indicated by a detail parameter.

In some aspects, the image generation model comprises a latent diffusion model. Some examples of the apparatus, system, and method further include a style prior model configured to generate a style guidance based on the detail parameter. Some examples further include a vectorization component configured to generate a vector image based on the synthetic image. Some examples further include a user interface including a fidelity parameter element and a detail parameter element.

### Generating Vector Images

Embodiments of the present disclosure include techniques for generating vector images with controllable fidelity to an input image and controllable detail. FIG. 5 shows an example of a pipeline for vectorizing images according to aspects of the present disclosure. The example shown includes input image 500, noise component 505, intermediate noise image 510, style prompt 515, style prior model 520, style embedding 525, content prompt 530, content encoder 535, content embedding 540, image generation model 545, vectorizable image 550, vectorization component 555, and vector image 560.

Noise component 505 is an example of, or includes aspects of, the corresponding element described with reference to FIG. 2. Style prior model 520 is an example of, or includes aspects of, the corresponding element described with reference to FIG. 2. Image generation model 540 is an example of, or includes aspects of, the corresponding element described with reference to FIG. 2. Vectorization component 555 is an example of, or includes aspects of, the corresponding element described with reference to FIG. 2.

In this example, the system receives a fidelity parameter between 0.0 and 1.0 and a detail parameter between 0.0 and 1.0. The fidelity parameter and the detail parameter determine various operations of noise component 505, style prior model 520, and image generation model 540. For example, noise component 505 applies an amount of noise to input image 500 to obtain intermediate noise image 510, where the amount of noise is determined based on the fidelity parameter. According to some aspects, the amount of noise added increases with a decrease in the fidelity parameter, and the amount of noise added decreases with an increase in the fidelity parameter. In at least some embodiments, the noise is added to an embedding of input image 500, and the intermediate noise “image” 510 is a noisy latent encoding.

The style prior model 520 receives style prompt 515 and generates style embedding 525 therefrom. Similarly, content encoder 535 receives content prompt 530 and generates content embedding 540 therefrom. According to some aspects, style embedding 525 is an image embedding in a multimodal embedding space, and encodes a representation of stylistic features to be transferred to a generated image. Content embedding 540, in contrast, may be text embedding in the multimodal embedding space, and encodes a representation of the content, structure, or subject(s) to be included in a generated image. According to some aspects, the detail parameter affects how the style embedding 525 is applied during image generation. For example, the style embedding 525 may have an overall weighting applied to it based on the detail parameter. A low detail parameter value may more heavily weight the style embedding 525 during generation. In some cases, the detail parameter influences which diffusion timestep(s) the style embedding 525 is applied. In at least some embodiments, the detail parameter affects prompt augmentation(s) applied to style prompt 515. An example scheme for achieving different levels of detail using the pipeline described with reference to FIG. 5 is given by Table 1. Increasing levels of detail reduce the influence of the style prompt with different prompt augmentation(s), weighting of the style embedding 525, and the number of diffusion timestep(s) in which the style embedding 525 is applied.

TABLE 1
Scheme for achieving 5 levels of detail in generated
vectorizable images. Detail level 1 is to the lowest
level of detail, and detail level 5 is the highest.

| | | | Diffusion |
|---|---|---|---|
| Detail | | Style | Timestep(s) |
| Level | Prompt Augmentation | Weighting | Style is Applied |
| 1 | “, high quality, simple, | medium | All |
| | minimal and clean design, | | |
| | flat colors with vector look, | | |
| | less gradients, minimalistic” | | |
| 2 | “, high quality, simple, | medium | [1000, 500] |
| | minimal and clean design, | | |
| | flat colors with vector look, | | |
| | less gradients, minimalistic” | | |
| 3 | “, high quality, simple and | medium | [1000, 500] |
| | clean design, flat colors with | | |
| | vector look, less gradients” | | |
| 4 | “, high quality, simple and | low | [1000, 400] |
| | clean design, flat colors with | | |
| | vector look, less gradients” | | |
| 5 | “, high quality” | low | [1000, 400] |

Image generation model 545 receives intermediate noise image 510, style embedding 525, and content embedding 540 as input and generates vectorizable image 550 therefrom. According to some aspects, vectorizable image 550 includes a level of fidelity to input image 500 as indicated by the fidelity parameter, and a level of detail as indicated by the detail parameter. Then, vectorization component 555 performs a vectorization process on vectorizable image 550 to produce vector image 560. Additional detail regarding the vectorization process is discussed with reference to FIG. 2.

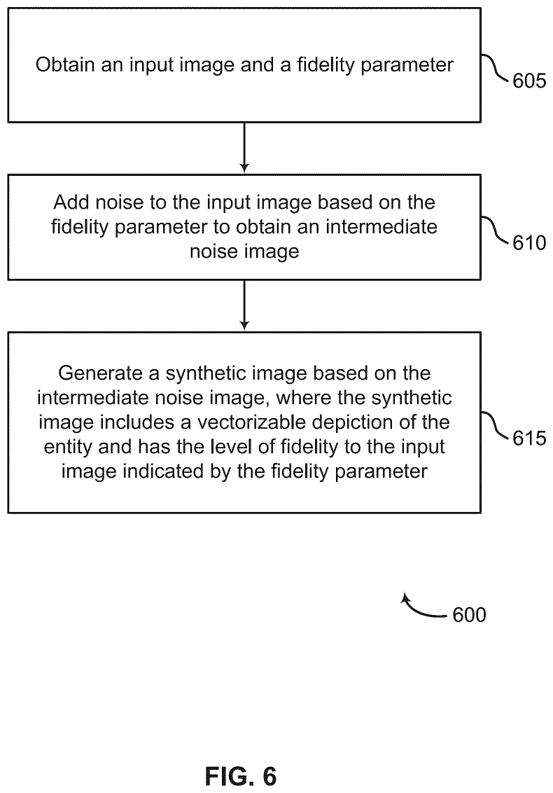

FIG. 6 shows an example of a method 600 for generating a synthetic image with controllable fidelity to an input image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the system obtains an input image and a fidelity parameter, where the input image depicts an entity and the fidelity parameter indicates a level of fidelity to the input image. In some cases, the operations of this step refer to, or may be performed by, an image processing apparatus as described with reference to FIGS. 1 and 2. In this example, a user may upload, select, or otherwise identify the input image via a user interface. The user may further select the fidelity parameter in the user interface via, e.g., a sliding element.

At operation 610, the system adds noise to the input image based on the fidelity parameter to obtain an intermediate noise image. In some cases, the operations of this step refer to, or may be performed by, a noise component as described with reference to FIGS. 2 and 5. The intermediate noise image may be a partially noised image. In some cases, system first encodes the input image to obtain a latent embedding of the image, and then adds noise to this latent embedding. According to some aspects, the amount of noise added increases with a decrease in the fidelity parameter. This may encourage the image generation to deviate from the input image in semantics, structure, and other aspects. In contrast, the amount of noise added may decrease with an increase in the fidelity parameter. In this case, the image generation process will make fewer changes to the input.

At operation 615, the system generates a synthetic image based on the intermediate noise image, where the synthetic image includes a vectorizable depiction of the entity and has the level of fidelity to the input image indicated by the fidelity parameter. In some cases, the operations of this step refer to, or may be performed by, an image generation model as described with reference to FIGS. 2 and 5. The image generation model may be a diffusion model as described in detail with reference to FIG. 3. By providing a partially noised input image, where the partial noising is determined by the fidelity parameter, embodiments are able to re-generate the input image as a vectorizable image with a controllable level of fidelity and detail. In some cases, embodiments further process the synthetic image to convert it to vector format.

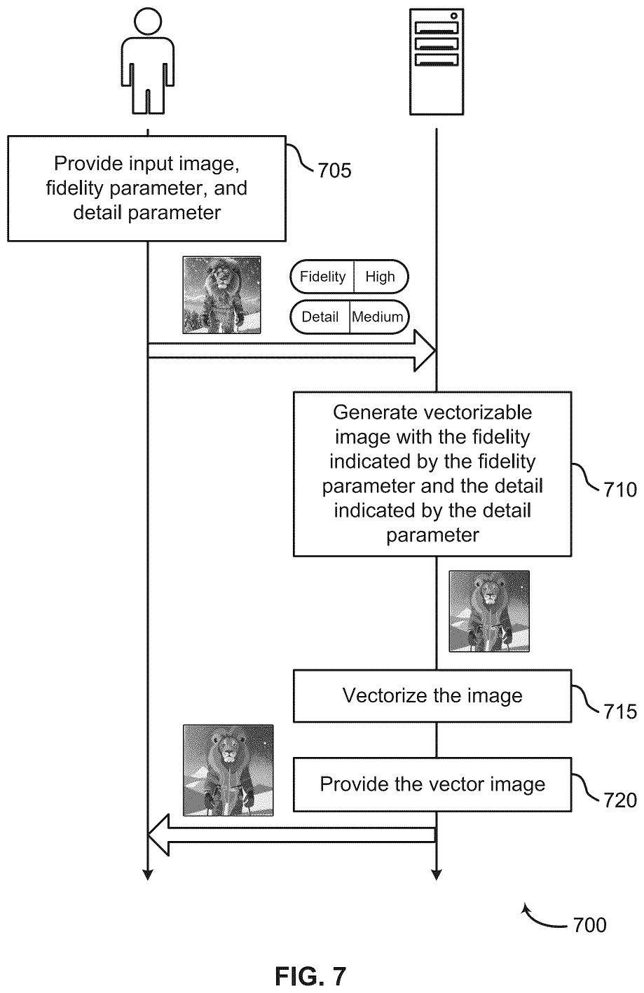

FIG. 7 shows an example of a method 700 for providing a user with a vector image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, a user provides an input image, fidelity parameter, and a detail parameter. The user may do so via a user interface. An example of a user interface is described in detail with reference to FIGS. 2 and 8.

At operation 710, the system generates vectorizable image with the fidelity indicated by the fidelity parameter and the detail indicated by the detail parameter. The system may do so via an image generation model. The image generation model may be, for example, a guided latent diffusion model as described in detail with reference to FIG. 3. Additional detail regarding how the image generation model incorporates the fidelity parameter and the detail parameter into the generation process is described with reference to FIGS. 5 and 6.

At operation 715, the system vectorizes the image. In some cases, the operations of this step refer to, or may be performed by, a vectorization component as described with reference to FIG. 2. Embodiments of the vectorization component are configured to identify distinct color regions and their boundaries within the image, and then convert these areas into a vector format, such as a scalable vector graphics (SVG) format. The vectorization component may use computer vision techniques and other heuristics to analyze the image to simplify gradients and textures into flat color areas.

At operation 720, the system provides the vector image. The system may do so via a user interface as described with reference to FIG. 2. According to some aspects, the system provides the vector image as well as an editing interface for making adjustments to the vector image.

FIG. 8 shows an example of a graphical user interface according to aspects of the present disclosure. The example shown includes original image 800, detail parameter selector element 805, and fidelity parameter selector element 810. The original image 800 may include a base prompt, which describes the content of the input image, e.g. as described with reference to FIG. 4.

After a user identifies original image 800 for input to the system, the system may present detail parameter selector element 805 and fidelity parameter selector element 810. In some embodiments, the system generates a grid of output images (in this example, a 5×4 grid), where the grid includes thumb-nail sized versions of output images along a detail dimension and a fidelity dimension. The thumbnails depict the corresponding level of detail and the corresponding level of fidelity along their respective axes that will be transferred to the input image after image processing by the system. The user may then select a detail parameter using detail parameter selector element 805 and a fidelity parameter using fidelity parameter selector element 810 and expect an image similar to the corresponding thumbnail.

For example, given the input image of the computer desk, if a “low” fidelity is selected (as indicated by the top row of the grid), there may be a loose semantic adherence to the input image. For example, the computer and the desk may have different color characteristics and structure characteristics. The viewing angle of the computer in the outputs is straight on, whereas the viewing angle of the input image is from off-center. However, if a “high” fidelity is selected (bottom row), the viewing angle, color characteristics, structure, and other semantics are generally preserved even at lower levels of detail.

FIG. 9 shows an example of a computing device 900 according to aspects of the present disclosure. The example shown includes computing device 900, processor(s) 905, memory subsystem 910, communication interface 915, I/O interface 920, user interface component(s), and channel 930.

In some embodiments, computing device 900 is an example of, or includes aspects of, vector image generation apparatus 100 of FIG. 1. In some embodiments, computing device 900 includes one or more processors 905 are configured to execute instructions stored in memory subsystem 910 to obtain an input image and a fidelity parameter, wherein the input image depicts an entity and the fidelity parameter indicates a level of fidelity to the input image; add noise to the input image based on the fidelity parameter to obtain an intermediate noise image; and generate, using an image generation model, a synthetic image based on the intermediate noise image, wherein the synthetic image includes a vectorizable depiction of the entity and has the level of fidelity to the input image indicated by the fidelity parameter.

According to some aspects, computing device 900 includes one or more processors 905. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 910 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 915 operates at a boundary between communicating entities (such as computing device 900, one or more user devices, a cloud, and one or more databases) and channel 930 and can record and process communications. In some cases, communication interface 915 is provided to enable a processing system coupled to a transceiver (e.g., a transmitter and/or a receiver). In some examples, the transceiver is configured to transmit (or send) and receive signals for a communications device via an antenna.

According to some aspects, I/O interface 920 is controlled by an I/O controller to manage input and output signals for computing device 900. In some cases, I/O interface 920 manages peripherals not integrated into computing device 900. In some cases, I/O interface 920 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 920 or via hardware components controlled by the I/O controller.

According to some aspects, user interface component(s) 925 enable a user to interact with computing device 900. In some cases, user interface component(s) 925 include an audio device, such as an external speaker system, an external display device such as a display screen, an input device (e.g., a remote control device interfaced with a user interface directly or through the I/O controller), or a combination thereof. In some cases, user interface component(s) 925 include a GUI, such as the one described with reference to FIG. 8.

Accordingly, the present disclosure describes methods for image processing, and specifically image vectorization. A first method includes obtaining an input image and a fidelity parameter, wherein the input image depicts an entity and the fidelity parameter indicates a level of fidelity to the input image; adding noise to the input image based on the fidelity parameter to obtain an intermediate noise image; and generating, using an image generation model, a synthetic image based on the intermediate noise image, wherein the synthetic image includes a vectorizable depiction of the entity and has the level of fidelity to the input image indicated by the fidelity parameter.

Some examples of the method, apparatus, non-transitory computer readable medium, and system further include obtaining a detail parameter indicating a level of detail for the synthetic image. Some examples further include generating style guidance based on the detail parameter, wherein the synthetic image is generated based on the style guidance and includes the level of detail indicated by the detail parameter.

Some examples of the method, apparatus, non-transitory computer readable medium, and system further include obtaining a text prompt. Some examples further include augmenting the text prompt based on the detail parameter, wherein the style guidance is generated based on the augmented text prompt. Some examples further include weighting the style guidance based on the detail parameter. Some examples further include providing the style guidance to the image generation model at a diffusion step selected based on the detail parameter.

Some examples of the method, apparatus, non-transitory computer readable medium, and system further include selecting a noise level based on the fidelity parameter, wherein the noise level decreases as the fidelity parameter increases. Some examples further include selecting a diffusion sampling schedule based on the fidelity parameter. In some aspects, an initial diffusion step of the diffusion sampling schedule increases as the fidelity parameter increases. Some examples further include generating a vector image based on the synthetic image.

A second method for image vectorization is described. One or more aspects of the method include obtaining an input image, a fidelity parameter, and a detail parameter; adding noise to the input image based on the fidelity parameter to obtain an intermediate noise image; generating a style guidance based on the detail parameter; and generating a synthetic image based on the intermediate noise image and the style guidance, wherein the synthetic image has a level of fidelity to the input image indicated by the fidelity parameter and has a level of detail indicated by the detail parameter.

Some examples of the method, apparatus, non-transitory computer readable medium, and system further include obtaining a text prompt. Some examples further include augmenting the text prompt based on the detail parameter, wherein the style guidance is generated based on the augmented text prompt. Some examples further include weighting the style guidance based on the detail parameter. Some examples of the method, apparatus, non-transitory computer readable medium, and system further include selecting a diffusion sampling schedule based on the fidelity parameter. Some examples further include providing the style guidance to the image generation model at a diffusion step selected based on the detail parameter. Some examples further include generating a vector image based on the synthetic image.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input image and a fidelity parameter, wherein the input image depicts an entity and the fidelity parameter indicates a level of fidelity to the input image;
adding noise to the input image based on the fidelity parameter to obtain an intermediate noise image; and
generating, using an image generation model, a synthetic image based on the intermediate noise image, wherein the synthetic image includes a vectorizable depiction of the entity and has the level of fidelity to the input image indicated by the fidelity parameter.

2. The method of claim 1, further comprising:
obtaining a detail parameter indicating a level of detail for the synthetic image; and
generating style guidance based on the detail parameter, wherein the synthetic image is generated based on the style guidance and includes the level of detail indicated by the detail parameter.

3. The method of claim 2, further comprising:
obtaining a text prompt; and
augmenting the text prompt based on the detail parameter, wherein the style guidance is generated based on the augmented text prompt.

4. The method of claim 2, further comprising:
weighting the style guidance based on the detail parameter.

5. The method of claim 2, further comprising:
providing the style guidance to the image generation model at a diffusion step selected based on the detail parameter.

6. The method of claim 1, wherein adding the noise comprises:
selecting a noise level based on the fidelity parameter, wherein the noise level decreases as the fidelity parameter increases.

7. The method of claim 1, wherein generating the synthetic image comprises:
selecting a diffusion sampling schedule based on the fidelity parameter.

8. The method of claim 7, wherein:
an initial diffusion step of the diffusion sampling schedule increases as the fidelity parameter increases.

9. The method of claim 1, further comprising:
generating a vector image based on the synthetic image.

10. A non-transitory computer readable medium storing code, the code comprising instructions executable by a processor to:
obtain an input image, a fidelity parameter, and a detail parameter;
add noise to the input image based on the fidelity parameter to obtain an intermediate noise image;
generate a style guidance based on the detail parameter; and
generate a synthetic image based on the intermediate noise image and the style guidance, wherein the synthetic image has a level of fidelity to the input image indicated by the fidelity parameter and has a level of detail indicated by the detail parameter.

11. The non-transitory computer readable medium of claim 10, the code further comprising instructions executable by the processor to:
obtain a text prompt; and
augment the text prompt based on the detail parameter, wherein the style guidance is generated based on the augmented text prompt.

12. The non-transitory computer readable medium of claim 10, the code further comprising instructions executable by the processor to:
weight the style guidance based on the detail parameter.

13. The non-transitory computer readable medium of claim 10, the code further comprising instructions executable by the processor to:
select a diffusion sampling schedule based on the fidelity parameter.

14. The non-transitory computer readable medium of claim 10, the code further comprising instructions executable by the processor to:
provide the style guidance to the image generation model at a diffusion step selected based on the detail parameter.

15. The non-transitory computer readable medium of claim 10, the code further comprising instructions executable by the processor to:
generate a vector image based on the synthetic image.

16. An apparatus comprising:
at least one processor;
at least one memory storing instructions executable by the at least one processor; and
the apparatus further comprising an image generation model comprising parameters stored in the at least one memory and configured to add noise to an input image based on a fidelity parameter to obtain an intermediate noise image and to generate a synthetic image based on the intermediate noise image, wherein the synthetic image has a level of fidelity to the input image as indicated by a fidelity parameter and has a level of detail as indicated by a detail parameter.

17. The apparatus of claim 16, further comprising:
a style prior model configured to generate a style guidance based on the detail parameter.

18. The apparatus of claim 16, further comprising:
a vectorization component configured to generate a vector image based on the synthetic image.

19. The apparatus of claim 16, wherein:
the image generation model comprises a latent diffusion model.

20. The apparatus of claim 16, further comprising:
a user interface including a fidelity parameter element and a detail parameter element.
